(19) United States
(12) Patent Application Publication
(10) Pub. No.: US 2004/0223224 A1
(43) Pub. Date: Nov. 11, 2004

(54) Light diffusing layer, light diffusing film, and light diffusing adhesive sheet

(75) Inventors: Makoto Murata, Shizuoka-shi (JP); Kensaku Higashi, Shizuoka-shi (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignee: TOMOEGAWA PAPER CO., LTD.

(21) Appl. No.: 10/836,253

(22) Filed: May 3, 2004

(30) Foreign Application Priority Data
May 6, 2003 (JP) 2003-127691

(51) Int. Cl. F21V 7/04

(52) U.S. Cl. 359/599; 362/31

(57) ABSTRACT

A light diffusing layer has a resin matrix and spherical fillers having different refractive index from the resin matrix, and a thickness of the light diffusing layer T (μm), a difference of refractive index Δn between the resin matrix and the spherical fillers, and a volume content Cv (%) of the spherical fillers to the light diffusing layer satisfy the formula 20≦T×Δn×Cv≦75. Furthermore, an adhesive can be contained in the resin matrix.

### BACKGROUND OF INVENTION

1. Technical Field

The present invention relates to a light diffusing layer, a light diffusing film, and a light diffusing adhesive sheet, which are desirably employed in lighting systems such as backlights for liquid crystal displays (LCD).

2. Background Art

In LCDs, various kinds of media are used, in addition to LCD cells, to control reflection, transmission, diffusion, refraction, and polarization of light. A diffusion film which is arranged on a light guide plate is typically used as such light diffusion media. Since incident light enters from a light source at an edge surface of the light guide plate in the case of backlight systems of the edge-lighted type, most of the outgoing light from the light guide plate is deflected from a line normal to the light guide plate to exit in a direction opposite to the light source. In addition, reflective dots printed on the light guide plate can be seen. Therefore, a so-called diffusing film is arranged on the light guide plate so as to make the reflective dots inconspicuous, and in addition, the exit angle increases toward the normal line.

The diffusion films may be categorized in three types depending on structure. That is to say, (1) a film in which light diffusing material having different refraction index from the film base material is contained; (2) a film having a resin layer on its surface on which fine concavoconvex parts are formed by a sand blasting method or heating and pressing with a press roll; and (3) a transparent film on which a coating containing light diffusion material is coated, are well known. In particular, since the coated type film (3) is easily produced and the optical properties thereof can be easily controlled by altering the mixture of raw materials, the film has been greatly advanced. A film which can condense outgoing light in a direction of a normal line is disclosed in Japanese Unexamined Patent Application Publication No. Hei 06-59107.

In the edge-lighted type backlight system, a diffusing film, two prism layers, and brightness improving film or the like are conventionally positioned, in that order, on the light guide plate. That is to say, the outgoing light from the light guide plate is once diffused over a wide angle, the light is condensed by the two prism layers which are crossed at a right angle and are arranged upward and then diffused in the vertical direction of the display surface. In addition, brightness is improved by the brightness improving film, if necessary.

However, as is disclosed in Monthly Display No. 11/2001 (published by Techno Times Co., Ltd., Nov. 1, 2001, p. 51 to 62, and p.68 to 79) the light guide plate of the backlight is greatly modified to further improve display brightness and to reduce the numbers of material parts. Specifically, by employing a method in which both faces of a prism light guide plate and a downward prism layer are used in combination, or a method in which micro-reflection elements or micro-deflection elements are arranged on a outgoing surface or a back surface of a light guide plate, etc., light which is condensed from the light guide plate in a narrow range of angles to relative to the normal line can be caused to exit. In the case in which the new type of light guide plate is used, since a conventional light diffusing film has too high diffusion characteristics, condensed light is wasted.

However, if the diffusing film is not used, patterns of prisms, micro-reflecting elements, or micro-deflection elements attached on the light guide plate are visible. Furthermore, a diffusing film having certain ranges of properties suitable for each use improves the display quality of LCDs.

A goniophotometer is used in a method to evaluate a light diffusing film. FIG. 1 shows a system to measure angle dependency of transmitted diffused light by a goniophotometer. Straight light from a light source 11 enters into a light diffusing film 13 at a predetermined angle (incident angle α). While a light receiving device 12 positioned behind the light diffusing film 13 is rotated on the light diffusing film 13 at constant pitch, diffused light strength at each angle (outgoing angle β) is measured. In this case, the incident angle α is fixed and the outgoing angle β is varied, although the incident angle α can be varied and the outgoing angle β can be fixed.

Furthermore, by arranging the light receiving device at the same side of the light diffusing film, not only the transmitted light, but also diffusion of reflect light, can be evaluated. Furthermore, the film is not evaluated alone, and a backlight having a light source and a light guide plate on its back can also be arranged with the film. In this way, the angle dependency of outgoing light can be measured in practical use.

In the case in which the above-mentioned conventional light diffusing film is measured by the goniophotometer, diffused light is detected along a wide range of outgoing angles, although straight transmitted light strength is reduced. That is, a light diffusing film in which straight transmitted light strength is not deteriorated and the light is diffused over only a narrow range of angles, has thus far not been obtained.

### SUMMARY OF THE INVENTION

The present invention was completed in consideration of the situation described above, and an object of the present invention is to provide a light diffusing medium having a structure which can diffuse incident light over an appropriate range of angles.

To solve the problems described above, the inventors researched about the quantification of angle dependency of light transmission strength required for the above-mentioned light diffusing film (light diffusing layer), and about the structure of the light diffusing layer to meet the requirements, that is, experiments having parameters such as kinds of material, compositions, thicknesses of layers, or the like. As a result, the present invention can supply a light diffusing layer which can diffuse incident light over an appropriate range of angles.

The present invention uses a light diffusing layer having a resin matrix and spherical fillers having a different refractive index from the resin matrix and has a thickness of the light diffusing layer T (μm), a difference of refractive index Δn between the resin matrix and the spherical fillers, and a volume content Cv (%) of the spherical fillers to the light diffusing layer, so as to satisfy the formula 20≦T×Δn×Cv≦75. Furthermore, it is desirable that the resin matrix which composes the light diffusing layer of the present invention have an adhesive, and that a refractive index of the adhesive be in a range from 1.40 to 1.70. It is desirable that the particle diameter of the spherical fillers which compose the light diffusing layer of the present invention be in a range from 1 μM to 10 μm, and that the thickness of the light diffusing layer containing the adhesive be in a range from 10 μm to 100 μm. A light diffusing film of the present invention has a transparent base material and the light diffusing layer specified in a first aspect of the invention on the base material, a light diffusing adhesive sheet of the present invention, has comprises the light diffusing layer specified according to a second aspect of the invention, and a release sheet on at least one surface of the light diffusing layer.

The present invention is further explained below. A resin matrix which composes the light diffusing layer of the present invention is not particularly limited as long as a resin material such as thermoplastic resin, thermosetting resin, or light-setting resin, has light permeability. In practice, polyethylene, polypropylene, cycloolefin resin, polyester resin, epoxy resin, polyurethane resin, silicone resin, acrylic resin or the like can be employed. In addition, an adhesive having pressure sensitive adhesiveness at ordinary temperatures as explained below is desirably employed.

As the adhesive of the resin matrix which composes the light diffusing layer of the present invention, polyester resin, epoxy resin, polyurethane resin, silicone resin, acrylic resin or the like can be employed. They can be used alone or in combination. In particular, acrylic resin is desirable since it has high optical transparency, a refractive index close to that of a TAC film which is a protecting film of a polarization plate, high reliability and history of use as an adhesive for polarization plates, and relatively reasonable price.

As the acrylic adhesive, a homopolymer of acrylic acid, an ester of the acrylic acid, methacrylic acid, an ester of the methacrylic acid, acrylamide, acrylonitrile, etc., and a copolymer thereof, and furthermore, a copolymer of at least one selected from these acrylic monomers and a vinyl monomers such as vinyl acetate, maleic anhydride, or styrene can be employed. In particular, a primary monomer which exhibits adhesiveness such as ethyl acrylate, butyl acrylate, or 2-ethylhexyl acrylate; a monomer which acts as a cohesive component such as vinyl acetate, acrylamide, acrylonitrile, styrene, or methacrylate; and a functional group containing monomer which improves adhesive strength and yields cross-linking origins such as acrylic acid, methacrylic acid, itaconic acid, maleic acid anhydrate, hydroxylethyl methacrylate, hydroxylpropylmethacrylate, dimethylaminoethylmethacrylate, methylolacrylamide, glycidylmethacrylate can be used. Furthermore, if necessary, a copolymer comprising fluorine containing acrylate or sulfur containing acrylate can be employed to control the refractive index. It is desirable that the glass transition point of these resins be in a range from −60° C. to −15° C., and that the polymerization average molecular weight be in a range from 100,000 to 2,000,000.

As the acrylic adhesive, a photopolymerization coating in which photopolymerization initiating agent or the like is added to an acrylic monomer and an oligomer having an acrylic group at a terminal end and having a side chain can be employed. After the photopolymerization coating is coated on a base material, since the coated layer becomes adhesive by irradiating UV, it can be used as the acrylic adhesive. If necessary, a metal-chelate-based, isocyanate-based, or epoxy-based cross-linking agents can be added to the acrylic adhesive alone or in combination. It is desirable that the refractive indexes of these adhesives be in a range from 1.40 to 1.70, and more desirably in a range from 1.45 to 1.55. In the present invention, polymethylmethacrylate, polycarbonate, polyethylene terephthalate, polyvinyl chloride resin, or the like having no pressure sensitive adhesiveness at ordinary temperature can also be used as the resin matrix.

As a spherical filler which is mixed and dispersed in the adhesive of the present invention, transparent fine particles of silica, acrylic resin, polystyrene resin, styrene-acryl copolymer resin, polyethylene resin, epoxy resin, silicone resin, silicone rubber or the like can be employed. It is desirable that an average particle diameter be in a range from 1 to 10 μm, and more desirably in a range from 1 to 5 μm. In the case in which the average particle diameter is less than 1 μm, light diffusing property is deteriorated and this is undesirable since reflective dots of the light guide plate, micro-reflection element, and micro-deflection element become visible. On the other hand, in the case in which the average particle diameter is greater than 10 μm, the particles are too coarse, aventurine-like patterns and glare can be seen in the background of the display, and contrast is deteriorated. The average particle diameter is measured by the Coulter counter method. It is generally desirable that the diameter of the fillers be uniform from the viewpoint of uniformity of optical properties of the light diffusing layer. On the other hand, two or more kinds spherical fillers of different materials and having different particle diameters can be dispersed in the adhesive at a constant ratio to finely control the diffusion properties.

As the transparent base material available in the present invention, a film of polyethylene terephthalate (PET), triacetylcellulose (TAC), polyacrylate, polyimide, polyether, polycarbonate, polysulfone, polyethersulfone, cellophane, aromatic polyamide, cycloolefin-based resin or the like can be employed. It is desirable that a thickness of the transparent base material be in a range from 20 to 200 μm, and more desirably in a range from 40 to 100 μm. In the case in which the thickness is less than 20 μm or greater than 200 μm, it may easily be difficult to handle. Furthermore, a thicker base material results in higher cost since more raw material is required.

A matrix resin and spherical fillers having different refractive indexes from the matrix resin which compose the light diffusing layer, the light diffusing film, and the light diffusing adhesive sheet of the present invention have a thickness of the light diffusing layer T (μm), a difference of refractive index Δn between the resin matrix and the spherical fillers, and a volume content Cv (%) of the spherical fillers to the light diffusing layer so as to satisfy the formula 20≦T×Δn×Cv≦75. The range is necessary to realize the light diffusing layer which is an object of the present invention in which incident light is diffused in a narrow range. This means that the diffusion of light is determined by these three parameters. In the case in which the product of the parameters T, Δn, and Cv are in this range, the light from the light guide plate is more efficiently utilized as a display of an LCD device. The product of the three parameters can be controlled within the range by setting appropriately T, Δn, and Cv which exhibit functions explained below.

More practically, the thickness of the light diffusing layer T (μm) is almost equal to a distance at which incident light exits from the light diffusing layer while diffusing. The light is diffused more widely as T increases, and more narrowly as T decreases. The difference in refractive index between the matrix resin and the spherical filler Δn expresses the degree of the diffusion of the light at an interface thereof, the light is diffused more widely as Δn increases, and more narrowly as Δn decreases. The volume content of the spherical filler to the light diffusing layer Cv expresses the width of an interface of the matrix resin and spherical filler, the light is diffused more widely as Cv increases, and more narrowly as Cv decreases. The case in which the product of these parameters is less than 20 is undesirable because the light diffusion becomes too low and reflection dots of the light guide plate, micro-reflection element, and micro-deflection element may be visible. On the other hand, when the product is more than 75, it is undesirable since the light diffusion becomes too high, the light from the light guide plate cannot be utilized efficiently, the display of the LCD device is darkened, and the contrast is deteriorated.

In the present invention, it is desirable that the thickness of the light diffusing layer be in a range of 2 to 200 μm. In the case in which the thickness is less than 2 μm, the light diffusion property is not sufficient since it is too thin, and in the case in which the thickness is more than 200 μm, light transmittance is deteriorated, and cost is increased since it requires a larger amount of raw material. In the case in which the resin matrix is an adhesive, it is desirable that the thickness of the light diffusing layer be in a range from 10 to 100 μm. If the thickness is less than 10 μm, adhesiveness is not exhibited, and if the thickness is more than 100 μm, since the adhesive exhibits fluidity at ordinary temperatures, the adhesive layer which is arranged on a display light source may move.

The light diffusing layer of the present invention can be used alone if the thickness is more than about 20 μm, or is used in a formation in which the light diffusing layer is formed on a transparent base material. On the other hand, the light diffusing adhesive sheet is formed by arranging at least one release sheet on at least one surface, desirably on both surfaces of the light diffusing layer. The light diffusing layer having adhesiveness of the present invention is ordinarily cut, carried, and kept in a stacked condition of a light diffusing adhesive sheet. Therefore, in the case in which the light diffusing adhesive sheet having release sheets on both surfaces of light diffusing layer obtained in the present invention is applied to a LCD device, one release sheet is removed, the adhesive surface is arranged on a polarizing plate, a phase difference plate, a liquid crystal panel, a prism sheet, a light guide plate, a contrast improving film, a light reflecting material or the like. Furthermore, the release sheet of the other side is removed and the adhesive surface is arranged to face another member.

The light diffusing layer of the present invention can be produced by melting with heat and mixing spherical fillers in a resin matrix of polyethylene terephthalate or the like, extruding and forming into a film shape. Alternatively, a coating in which spherical fillers are dispersed in a resin matrix solution is casted on a highly smooth roll or a belt, the solvent is volatilized to exfoliate the product. Similarly, the light diffusing film of the present invention can be produced by coating a coating in which spherical fillers are dispersed in a resin matrix solution, on a transparent base material such as a transparent PET film or the like. The light diffusing adhesive sheet is produced as explained below, for example. First, a coating in which spherical fillers are dispersed in a resin matrix such as an adhesive is coated on a release sheet and is dried to form the light diffusing layer. Then, another release sheet is laminated on the light diffusing layer to prepare the light diffusing adhesive sheet. It should be noted that ethyl acetate, butyl acetate, acetone, methylethylketone, methylisobutylketone, cyclohexanone, toluene, xylene or the like can be added to the coating to improve dispersibility of the spherical filler and coating property such as wettability, leveling property, and drying property.

The spherical fillers are dispersed by using mixing, agitating, and dispersing devices such as a disper, ajiter, ball-mill, and attritor. It is desirable to perform degassing of the coating before the coating process. The coating for light diffusing layer is performed by using a reverse coater, dam coater, comma coater, die coater, doctor bar coater, gravure coater, micro-gravure coater, roll coater or the like. Furthermore, to cure and stabilize the adhesive component, the light diffusing adhesive sheet can be kept for about 1 day to 2 weeks at room temperature or 30 to 60° C. rolled or in sheets.

Quantitive indicator of light diffusion property desirable for the light diffusing film which diffuses incident light in an appropriate range of angles is explained. FIG. 2 shows an example of angle dependency of light strength of transmitted light (forward scattered light) which is transmitted forward, when light enters the light diffusing layer at 0° of the incident angle by using a goniophotometer. (a) shows light strength P(160) which is transmitted to a range in the forward 160° (outgoing angle is −80° to 80°). (b) shows light strength P(60) which is transmitted to a range in the forward 60° (outgoing angle is −30° to 30°). (c) shows light strength P(20) which is transmitted to a range in the forward 20° (outgoing angle is −10° to 10°). P(60)/P(160) is defined as a ratio of transmitted light in the forward 60°, P(20)/P(160) is defined as a ratio of transmitted light in the forward 20°. The inventors examined the angle dependency of transmitted light required for the light diffusing layer appropriate for display devices, and as a result, it became clear that the ratio of transmitted light in the forward 60° must be not less than 90%, and that the ratio of transmitted light in the forward 20° must be not more than 80%. In the present invention, this range is the quantitive indicator of the desirable light diffusion property.

### BRIEF DESCRIPTION OF THE DRAWINGS

FIG. 1 is a schematic diagram showing a measuring system of angle dependency of transmitted diffused light in Example of the present invention.

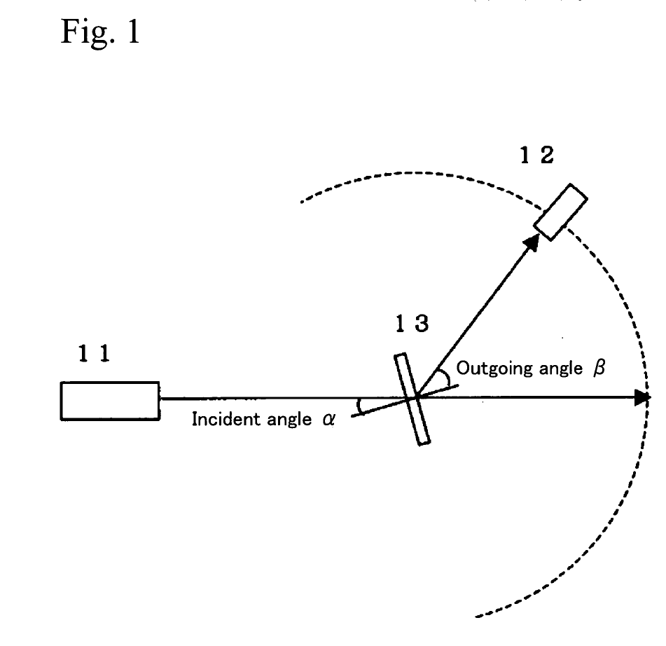

FIG. 2 is a drawing showing an outgoing angle dependency of transmitted light transmitted from the light diffusing film, (a) shows a strength of the light transmitted to a range in the forward 160°, (b) shows a strength of the light transmitted to a range in the forward 60°, and (c) shows a strength of the light transmitted to a range in the forward 20°.

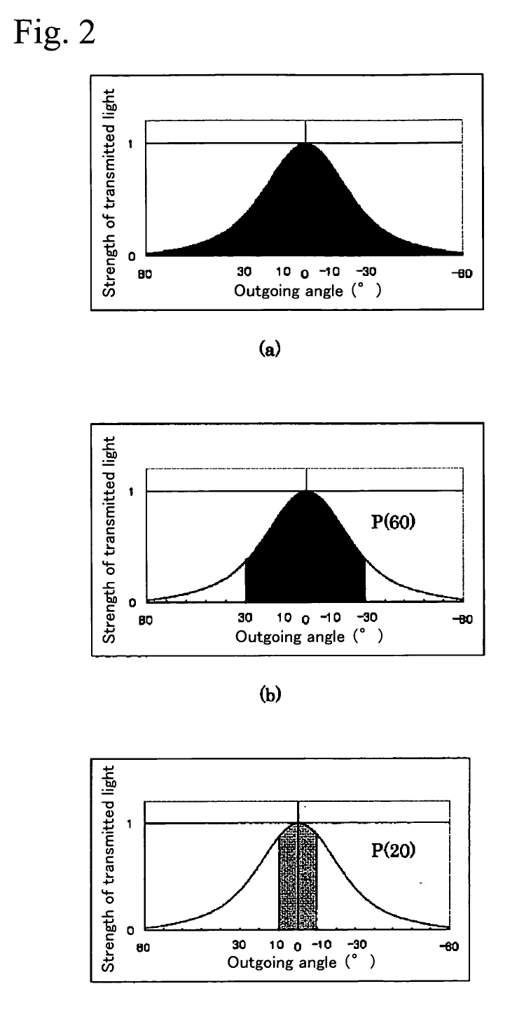

FIG. 3 is a drawing showing an outgoing angle dependency of the transmitted light of the light diffusing adhesive sheet of Example 1 of the present invention.

FIG. 4 is a drawing showing an outgoing angle dependency of the transmitted light of the light diffusing adhesive sheet of Example 7 of the present invention.

FIG. 5 is a drawing showing an outgoing angle dependency of the transmitted light of the light diffusing adhesive sheet of Comparative Example 1.

FIG. 6 is a drawing showing an outgoing angle dependency of the transmitted light of the light diffusing adhesive sheet of Comparative Example 3.

FIG. 7 is a schematic diagram showing a visual examination of an Example of the present invention.

### EXAMPLES

The present invention is further explained by way of examples. The present invention is not limited thereto.

### Examples 1 to 7

Light diffusing adhesive sheets of Examples 1 to 7 were prepared by methods described below. 0.2 parts by weight of isocyanate based cross-linking agent (Trade name: D-90, produced by Soken Chemical & Engineering) was added to 100 parts by weight of acrylic based adhesive having refractive index of 1.47, specific gravity of 0.81 g/cm³ (Trade name: SK-DYNE H-SF, total solid 30%, diluted with ethyl acetate, produced by Soken Chemical & Engineering) to prepare a base coating. Each spherical filler shown in Examples 1 to 7 of Table 1 was added to the base coating, the spherical fillers were dispersed by agitating by an ajiter for 30 minutes, to prepare 7 kinds of coatings for a light diffusing layer. Each coating was coated to polyethylene terephthalate release films having a thickness of 38 μm (Trade name: 38PF, produced by LINTEC) by a comma coater, to form predetermined thicknesses after drying. After the films were dried and the light diffusing layers were formed on each film, polyethylene terephthalate release films having a thickness of 38 μm (Trade name: 3801, produced by LINTEC) were laminated on the light diffusing layers, to obtain the light diffusing adhesive sheet of Examples 1 to 7.

Table 1 shows the kind, refractive index, specific gravity, particle diameter, and content (parts by weight) of the spherical filler; thickness of light diffusing layer T, difference of refractive index Δn, volume content of the filler Cv, and product of T, Δn, and Cv; total light transmittance; and Haze value, of each light diffusing layer. In Table 1, total light transmittance Tt (%) and Haze value Hz (%) were measured by a Hazemeter (Trade name: NDH2000, produced by NIPPON DENSHOKU INDUSTRIES).

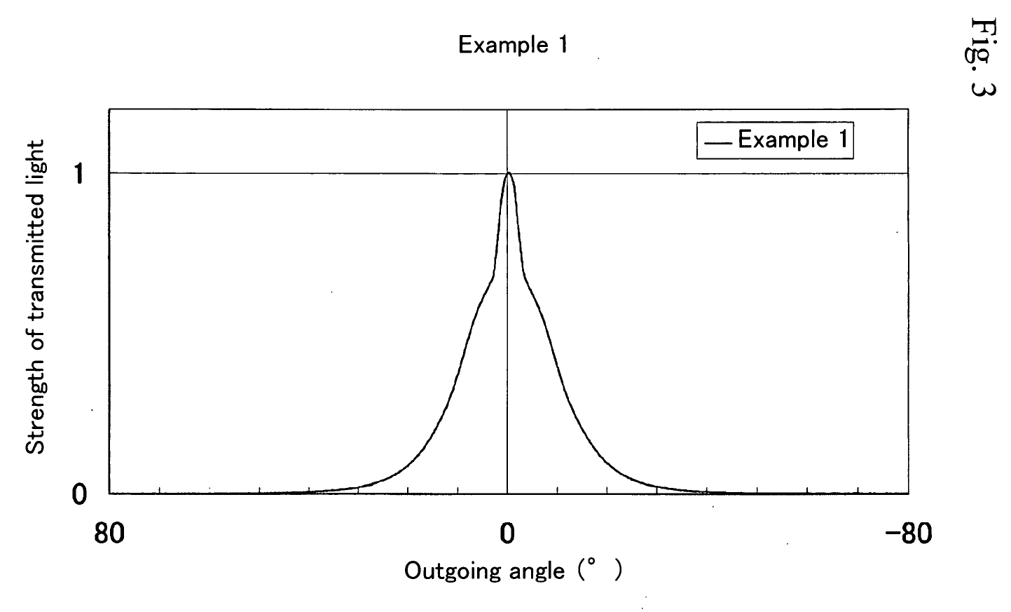

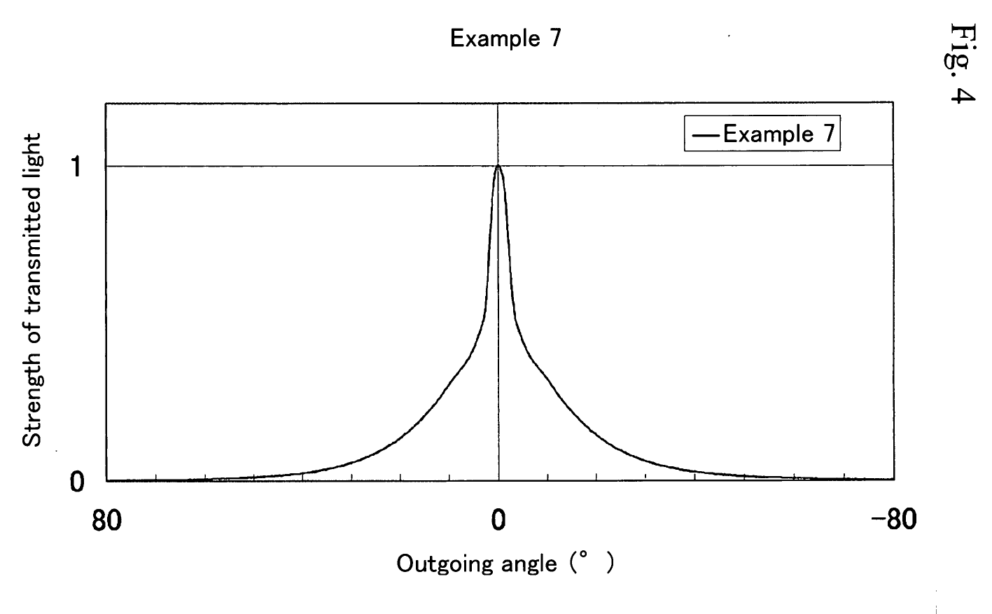

The transmitted light within a range in the forward 60° and forward 20° was measured as described below. Light was directed into each sheet of the Examples at an incident angle of 0°, strength of transmitted light was measured by a goniophotometer (Trade name: GP-5, produced by Murakami Color Research Laboratory) at outgoing angles in a range of −80 to 80°, and a ratio of transmitted light in the forward 60° and a ratio of transmitted light in the forward 20° were calculated. The results are shown in Table 2. FIG. 3 shows the angle dependency of strength of transmitted light in Example 1, and FIG. 4 shows the angle dependency of strength of transmitted light in Example 7.

### Comparative Examples 1 to 4

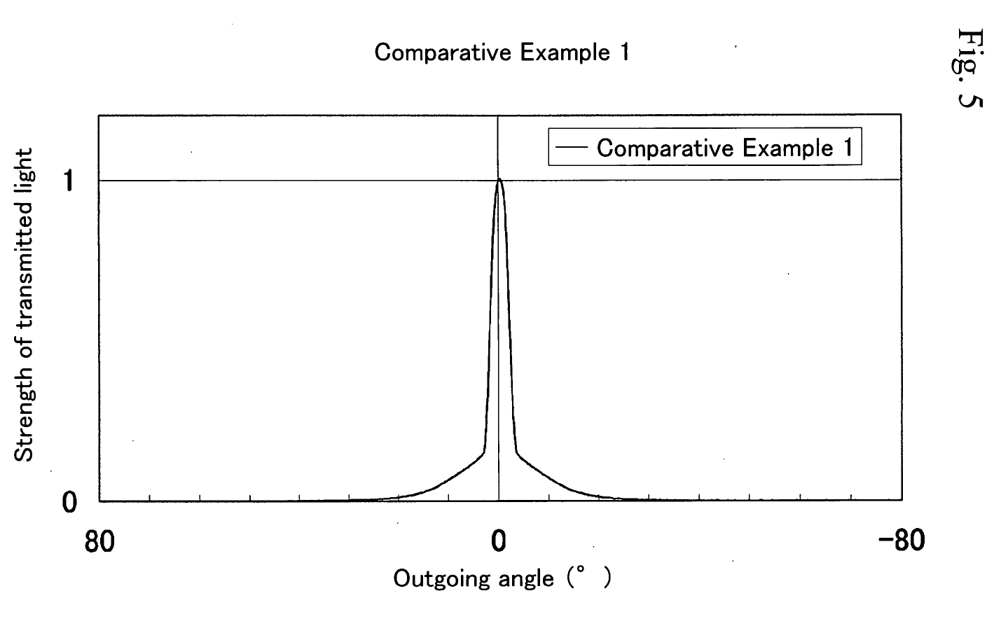

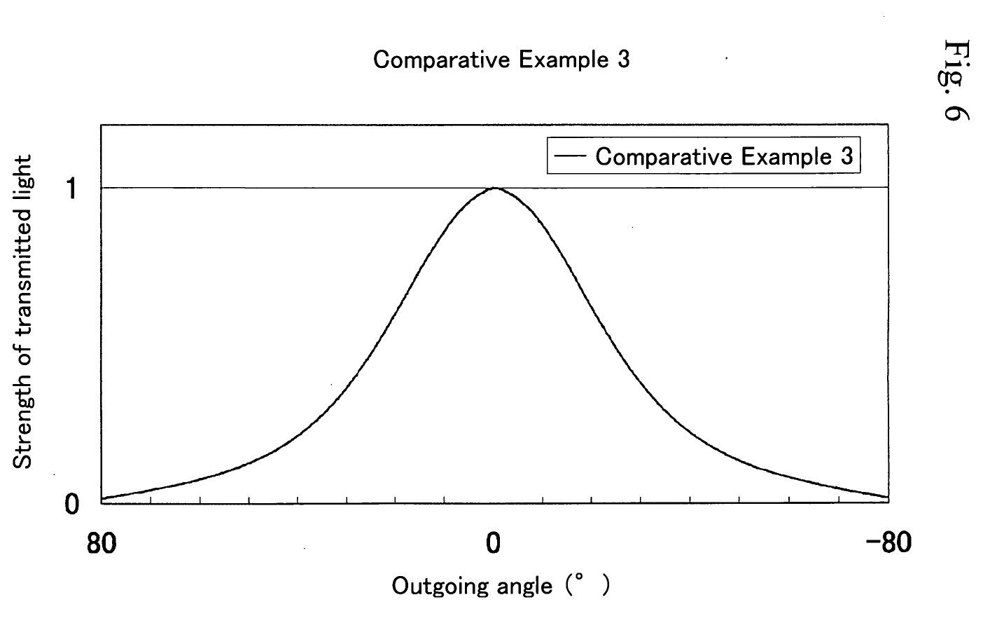

In a manner similar to Examples 1 to 7, four kinds of light diffusing adhesive sheets were produced by using each of the spherical fillers shown in Comparative Examples 1 to 4 in Table 1. Each property of the light diffusing sheets of Comparative Examples 1 to 4 were measured by the methods similar to Examples. These measured values; thickness of light diffusing layer T, difference of refractive index Δn, and volume content of filler Cv obtained from the values; and product of T, Δn, and Cv, are shown in Tables 1 and 2 together with the values of Examples. FIG. 5 shows the angle dependency of strength of transmitted light in Comparative Example 1, and FIG. 6 shows the angle dependency of the strength of transmitted light in Comparative Example 3.

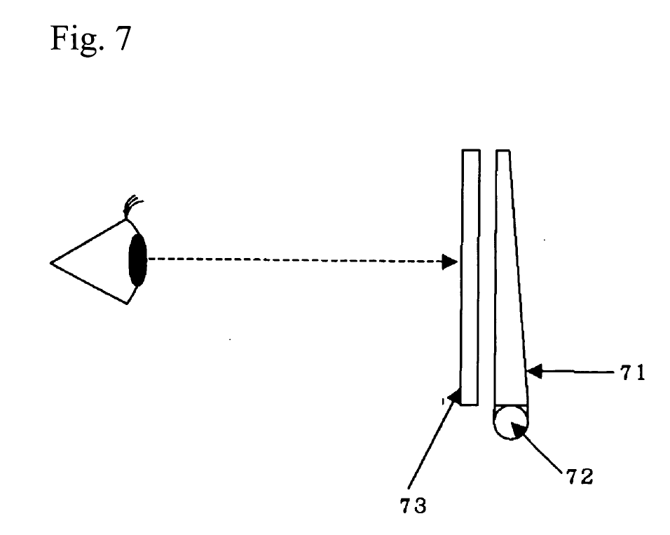

Visual examination of each sheet of the Examples and Comparative Examples was performed as shown in FIG. 7. That is, a light diffusing adhesive sheet (73) is put on a light guide plate unit of an edge light system (71), a light is turned on, and it is observed whether or not reflection dots of a light guide plate can be seen through the sheet are visible from a direction of normal line to the sheet. The results are shown in Table 2.

As is clear from Table 2, the light diffusing adhesive sheets of Examples 1 to 7 having properties in the range of 20≦T×Δn×Cv≦75, exhibit not less than 90% of the ratio of transmitted light in the forward 60°, and not more than 80% of the ratio of transmitted light in the forward 20°. The sheets efficiently diffuse incident light to a narrow range, and the reflection dots of light guide plate positioned therebehind cannot be seen. On the other hand, in the case of the light diffusing adhesive sheet of Comparative Example 1 and 2 in which T×Δn×Cv is less than 20, the reflective dots of the light guide plate are seen through the sheet, it cannot meet the requirement to make the reflective dots inconspicuous, which is originally required as the light diffusing sheet. In the case of the light diffusing adhesive sheet of Comparative Examples 3 and 4 in which T×Δn×Cv is more than 75, the ratio of transmitted light in the forward 60° is deteriorated, it is obvious that they cannot efficiently diffuse incident light to a narrow range, which is an object of the present invention.

TABLE 1

| | | | | Average | | | Difference | | | | |
|---|---|---|---|---|---|---|---|---|---|---|---|
| | | Refract- | Specific | particle | Content | Thickness | of | Volume | T × | Total light | |
| | | ive | gravity | diameter | (parts by | of layer T | refractive | content Cv | Δn × | transmittance | Haze |
| | Kind of spherical filler | index | (g/cm³) | (μm) | weight) | (μm) | index Δn | (%) | Cv | (%) | (%) |
| Example 1 | Silicone resin particle | 1.43 | 1.32 | 4.5 | 14.4 | 25 | 0.04 | 23.1 | 23.1 | 89.5 | 85.8 |
| | (Tospearl 45, Pro- | | | | | | | | | | |
| | duced by GE Toshiba | | | | | | | | | | |
| | Silicones) | | | | | | | | | | |
| Example 2 | Silicone resin particle | 1.42 | 1.30 | 2.2 | 14.4 | 25 | 0.05 | 23.0 | 28.8 | 89.4 | 83.3 |
| | (MUT-31, Produced | | | | | | | | | | |
| | by Nikko Rica) | | | | | | | | | | |
| Example 3 | As above | 1.42 | 1.30 | 2.2 | 14.4 | 50 | 0.05 | 23.0 | 57.5 | 90.1 | 90.5 |
| Example 4 | Silicone rubber part- | 1.40 | 0.99 | 5.0 | 7.8 | 25 | 0.07 | 17.5 | 30.6 | 89.6 | 86.1 |
| | icle (KMP600, Pro- | | | | | | | | | | |
| | duced by Shin-Etsu | | | | | | | | | | |
| | Chemical) | | | | | | | | | | |
| Example 5 | As above | 1.40 | 0.99 | 5.0 | 14.4 | 25 | 0.07 | 28.2 | 49.4 | 89.7 | 89.1 |
| Example 6 | Polystyrene resin part- | 1.59 | 1.05 | 3.5 | 3.3 | 25 | 0.12 | 10.2 | 30.6 | 87.2 | 86.8 |
| | icle (SX-350, Pro- | | | | | | | | | | |
| | duced by Soken | | | | | | | | | | |
| | Chemical & Engineer- | | | | | | | | | | |
| | ing) | | | | | | | | | | |
| Example 7 | As above | 1.59 | 1.05 | 3.5 | 7.8 | 25 | 0.12 | 16.6 | 49.8 | 85.2 | 89.6 |
| Comparative | Silicone resin particle | 1.42 | 1.30 | 2.2 | 7.8 | 25 | 0.05 | 13.7 | 17.1 | 89.2 | 78.5 |
| Example 1 | (MUT-31, Pro- | | | | | | | | | | |
| | duced by Nikko Rica) | | | | | | | | | | |
| Comparative | PMMA resin particle | 1.49 | 1.19 | 5.0 | 14.4 | 25 | 0.02 | 24.6 | 12.3 | 87.3 | 64.5 |
| Example 2 | (MX-500, Produced by | | | | | | | | | | |
| | Soken Chemical & | | | | | | | | | | |
| | Engineering) | | | | | | | | | | |
| Comparative | Polystyrene resin part- | 1.59 | 1.05 | 3.5 | 14.4 | 25 | 0.12 | 26.8 | 80.4 | 81.7 | 90.4 |
| Example 3 | icle (SX-350, Pro- | | | | | | | | | | |
| | duced by Soken | | | | | | | | | | |
| | Chemical & | | | | | | | | | | |
| | Engineering) | | | | | | | | | | |
| Comparative | Silicone rubber part- | 1.40 | 0.99 | 5.0 | 14.4 | 50 | 0.07 | 28.2 | 91.7 | 90.6 | 91.4 |
| Example 4 | icle (KMP600, Pro- | | | | | | | | | | |
| | duced by Shin-Etsu | | | | | | | | | | |
| | Chemical) | | | | | | | | | | |

TABLE 2

| | Ratio of transmitted | Ratio of transmitted | |
|---|---|---|---|
| | light in the forward | light in the forward | Visual |
| | 60° (%) | 20° (%) | evaluation |
| Example 1 | 97.7 | 69.9 | ◯ |
| Example 2 | 98.4 | 78.4 | ◯ |
| Example 3 | 91.0 | 61.3 | ◯ |
| Example 4 | 97.6 | 69.0 | ◯ |
| Example 5 | 91.5 | 49.7 | ◯ |
| Example 6 | 93.8 | 62.9 | ◯ |
| Example 7 | 91.7 | 57.7 | ◯ |
| Comparative | 99.5 | 87.2 | X |
| Example 1 | | | |
| Comparative | 99.9 | 96.2 | X |
| Example 2 | | | |
| Comparative | 77.0 | 33.7 | ◯ |
| Example 3 | | | |
| Comparative | 84.8 | 40.8 | ◯ |
| Example 4 | | | |

Visual evaluation
◯: Reflective dots of the light guide plate cannot be seen transparently.
X: Reflective dots of the light guide plate can be seen transparently.

As described above, in the light diffusing layer containing resin matrix and spherical fillers having different refractive index from the resin matrix of the present invention, since the thickness of the light diffusing layer T (μm), difference of refractive index between the resin matrix and the spherical fillers Δn, and volume content of the spherical filler to the light diffusing layer Cv (%) satisfy the formula 20≦T×Δn×Cv≦75, the ratio of transmitted light in the forward 60° is not less than 90%, and the ratio of transmitted light in the forward 20° is not more than 80%, and incident light can be diffused to an appropriate range of angles. Therefore, the present invention can supply the light diffusing layer and the light diffusing adhesive sheet suitable for a lighting device such as a backlight of LCD devices.

What is claimed is:

1. A light diffusing layer comprising:
a resin matrix; and
spherical fillers having a different refractive index from that of the resin matrix;
wherein a thickness of the light diffusing layer T (μm), a difference of refractive index Δn between the resin matrix and the spherical fillers, and a volume content Cv (%) of the spherical fillers to the light diffusing layer satisfy the formula 20≦T×Δn×Cv≦75.

2. The light diffusing layer according to claim 1, wherein the resin matrix comprises an adhesive.

3. The light diffusing layer according to claim 2, wherein a refractive index of the adhesive is in a range from 1.40 to 1.70.

4. The light diffusing layer according to claim 1, wherein a particle diameter of the spherical fillers is in a range from 1 μm to 10 μm.

5. The light diffusing layer according to claim 1, wherein a thickness of the light diffusing layer is in a range from 10 μm to 100 μm.

6. A light diffusing film comprising a transparent base material and the light diffusing layer according to claim 1.

7. A light diffusing adhesive sheet comprising the light diffusing layer according to claim 2, and a release sheet on at least one surface of the light diffusing layer.
